(19) United States
(12) Patent Application Publication
(10) Pub. No.: US 2018/0051398 A1
(43) Pub. Date: Feb. 22, 2018

(54) CARBON FIBER LAYER HAVING CARBON COATING

(71) Applicant: KOREA RAILROAD RESEARCH INSTITUTE, UIWANG-SI (KR)

(72) Inventors: CHUL MIN PARK, GWANGMYEONG-SI (KR); YONG HYEON CHO, SEOUL (KR)

(21) Appl. No.: 15/552,519

(22) PCT Filed: Apr. 7, 2016
(86) PCT No.: PCT/KR2016/003664

§ 371 Date: Aug. 22, 2017

(30) Foreign Application Priority Data
Apr. 8, 2015 (KR) 10-2015-0049905

(51) Int. Cl. D01F 9/21; D01F 9/26

(52) U.S. Cl. CPC D01F 9/21; C08J 5/042; D01F 9/26

(57) ABSTRACT

A carbon fiber layer having a carbon coating is provided. The disclosed carbon fiber layer having a carbon coating includes: a carbon fiber layer in which a plurality of carbon fibers are arrayed; and a thin carbon film layer, comprising carbon, coated on the surface of the carbon fiber layer.

### CROSS-REFERENCE TO RELATED APPLICATIONS

This application claims priority to PCT Application No. PCT/KR2016/003664 having a filing date of Apr. 7, 2016, based off of KR 10-2015-0049905 having a filing date of Apr. 8, 2015, the entire contents of which are hereby incorporated by reference.

### FIELD OF TECHNOLOGY

The following relates to a carbon fiber layer to which a carbon coating is applied, and more particularly, to a carbon fiber layer to which a carbon coating is applied, which has reinforced mechanical properties and interlayer binding force and improved electrical properties by applying a thin carbon film layer to a woven carbon fiber layer such as carbon fiber reinforced plastic (CFRP).

### BACKGROUND

As the depletion of fossil fuels becomes a serious social problem, a need for eco-friendly lightweight materials for reducing carbon dioxide is increasing. Lightweight materials can improve consumption of fossil fuels when used in automobiles, aircraft, vessels and rail vehicles.

In the field of automobiles, a carbon fiber is widely applied not only to the body but also to the interior to reduce the weight of a vehicle, and thus speed and fuel efficiency are improved. A total of 53% of the Airbus A350, including its wing and body, is made from carbon fibers, which can significantly improve fuel efficiency and stability by increasing rigidity and dramatically reducing weight.

In particular, it is required to reduce the shaft weight for maintenance of the track subjected to a load and a decrease in running resistance at high speed in rail vehicles. Particularly, it is required to reduce weight for reduction of electric energy in urban railways which exhibit a lot of acceleration and deceleration.

In addition, it is possible to have a stable braking effect at high speed by reducing the weight of the vehicle and to remarkably reduce construction costs by simplifying a structure such as a bridge.

In order to reduce the weight of rail vehicles having these advantages, various lightweight materials have been under development. Particularly, in order to reduce the weight of rail vehicles, advanced materials such as stainless steel, high strength aluminum, a carbon fiber composite and a flame-retardant magnesium alloy, all of which are lighter than steel, are applied to parts of the body, truck and the exterior/interior of the rail vehicle.

Materials which are currently attracting attention as a lightweight material are high strength aluminum, flame-retardant magnesium, a carbon fiber composite (carbon fiber reinforced plastic (CFRP)) and the like. Here, the CFRP is excellent in price and three-dimensional processability, but has poor mechanical properties compared to other lightweight materials, and thus exhibits poor interlayer adhesive strength. Therefore, there is a need for improvement thereof.

The related art of the present invention is disclosed in Korean Patent Application Publication No. 2013-0018028 (Published on Feb. 20, 2013; titled “Apparatus for Preparing Carbon Fiber”).

### SUMMARY

An aspect relates to a carbon fiber layer to which a carbon coating is applied, which has increased mechanical strength and interlayer adhesive strength and improved electrical properties.

A carbon fiber layer to which a carbon coating is applied according to embodiments of the present invention includes: a carbon fiber layer formed by arranging a plurality of carbon fibers; and a thin carbon film layer applied to a surface of the carbon fiber layer and including carbon.

According to embodiments of the present invention, the carbon fiber layer may be formed by weaving a plurality of carbon fibers.

According to embodiments of the present invention, the carbon fiber layer may include a carbon-arranged layer including the plurality of carbon fibers arranged in parallel; and a carbon fiber-connecting material filling a space between a plurality of carbon fibers to bind the carbon fibers.

According to embodiments of the present invention, the carbon fiber-connecting material may include a thermosetting resin.

According to embodiments of the present invention, the carbon fiber-connecting material may include epoxy or unsaturated polyester.

According to embodiments of the present invention, the thin carbon film layer may be deposited on both surfaces of the carbon fiber layer.

According to embodiments of the present invention, the thin carbon film layer may be applied to the carbon fiber layer by a dry-plating method.

According to embodiments of the present invention, the thin carbon film layer may be applied to the carbon fiber layer by a sputtering method.

According to embodiments of the present invention, the thin carbon film layer may be applied to the carbon fiber layer after a surface of the carbon fiber layer is etched.

According to embodiments of the present invention, the thin carbon film layer may be applied to a surface of the carbon fiber layer after a surface of the carbon fiber layer is flattened through etching.

According to embodiments of the present invention, the thin carbon film layer applied to the carbon fiber layer may have a thickness of 100 to 200 nm.

According to embodiments of the present invention, the thin carbon film layer applied to the carbon fiber layer may have a thickness of 145 to 155 nm.

A carbon fiber layer to which a carbon coating is applied according to embodiments of the present invention can maintain high elasticity of a carbon fiber layer, have reinforced rigidity, and simultaneously have increased adhesive strength between a carbon fiber layer and a thin carbon film layer by sputtering a material including carbon on a surface of a carbon fiber layer such as CFRP to form a thin carbon film layer.

In addition, the thin carbon film layer can be uniformly applied due to a decrease in bending of the carbon fiber layer by applying the thin carbon film layer after the carbon fiber layer is etched.

Additionally, since the carbon fiber layer according to embodiments of the present invention has increased rigidity compared to a carbon fiber layer such as CFRP to which a thin carbon film layer is not applied, the number, weight and cost of the carbon fiber layer for implementing the same rigidity can be reduced.

In addition, the thin carbon film layer can be applied to the carbon fiber layer to improve electrical performance.

### BRIEF DESCRIPTION

Some of the embodiments will be described in detail, with reference to the following figures, wherein like designations denote like members, wherein:

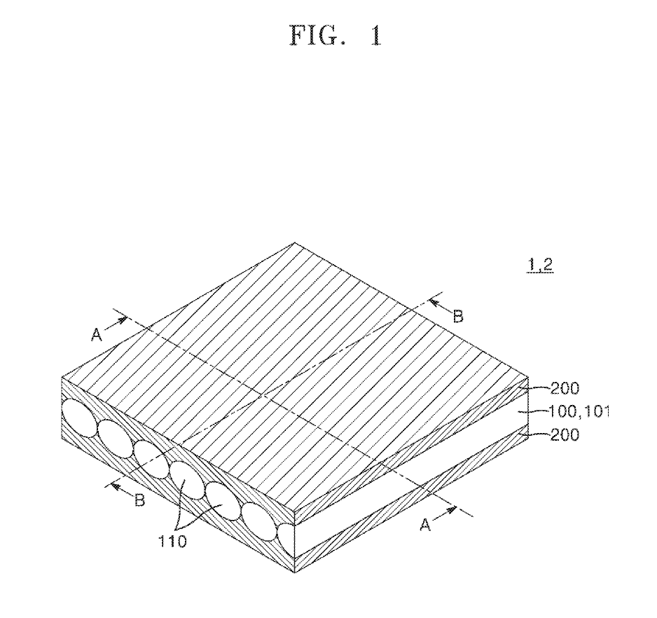

FIG. 1 is a perspective view of a carbon fiber layer to which a carbon coating is applied according to a first embodiment of the present invention;

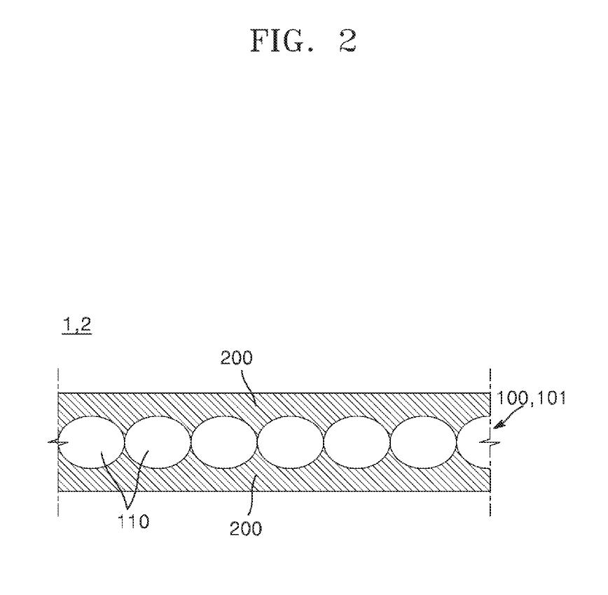

FIG. 2 is an A-A cross-sectional view of FIG. 1;

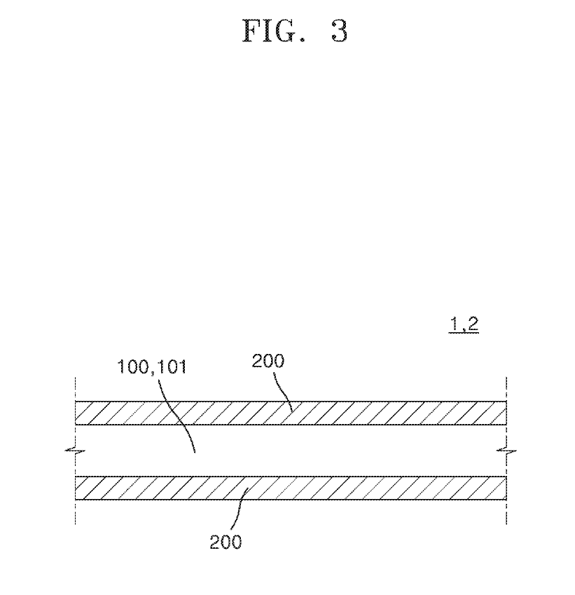

FIG. 3 is a B-B cross-sectional view of FIG. 1;

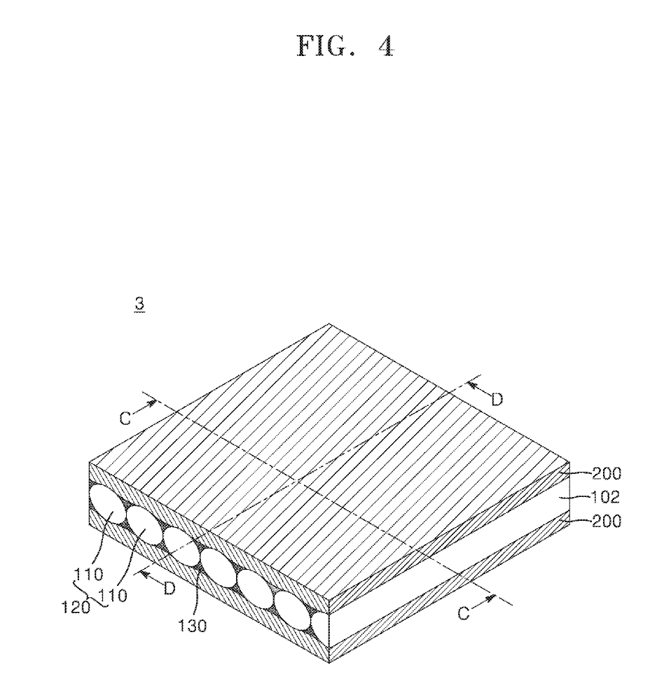

FIG. 4 is a perspective view of a carbon fiber layer to which a carbon coating is applied according to a second embodiment of the present invention;

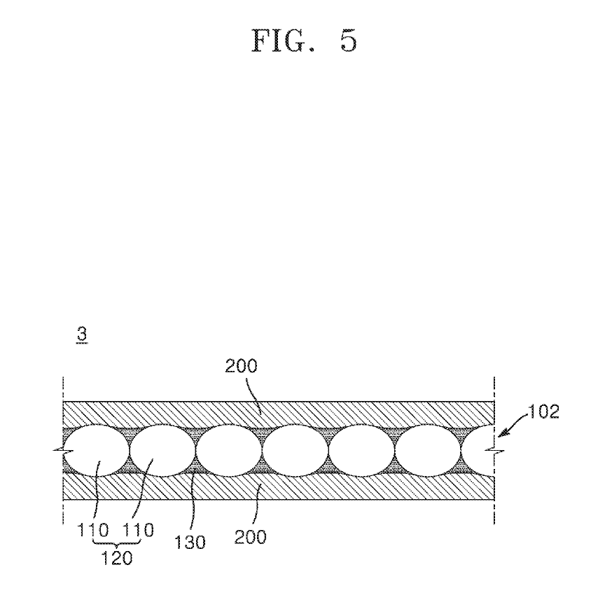

FIG. 5 is a C-C cross-sectional view of FIG. 4;

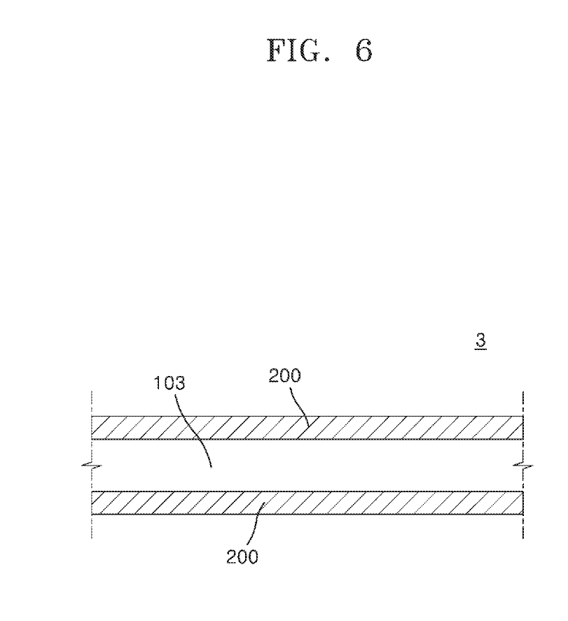

FIG. 6 is a D-D cross-sectional view of FIG. 4;

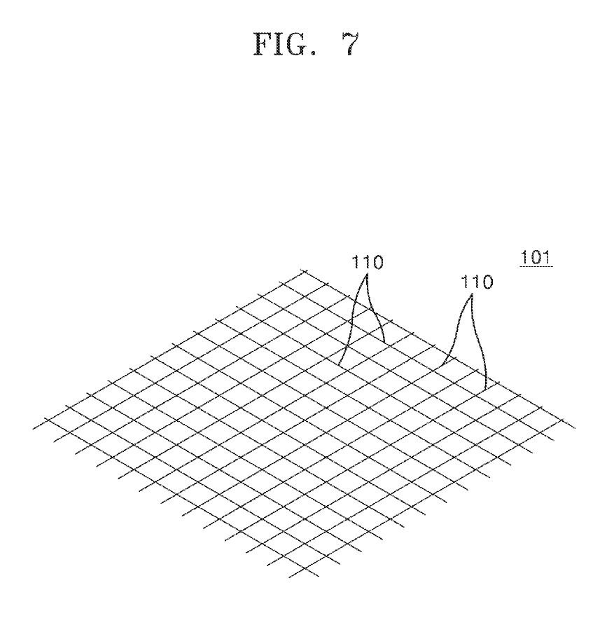

FIG. 7 is a view illustrating that carbon fibers are woven in a carbon fiber layer to which a carbon coating is applied according to a first embodiment of the present invention;

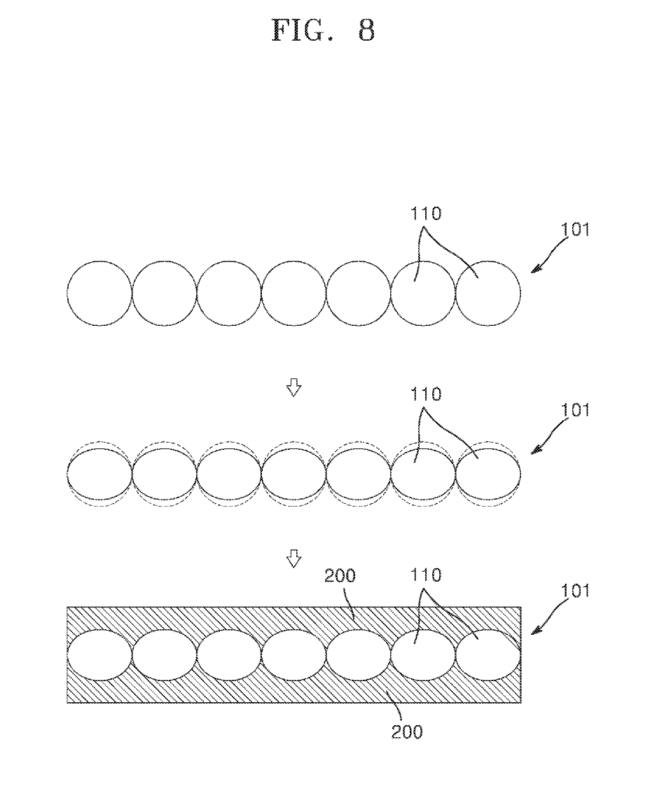

FIG. 8 is a view illustrating a process of manufacturing a carbon fiber layer to which a carbon coating is applied according to a first embodiment of the present invention;

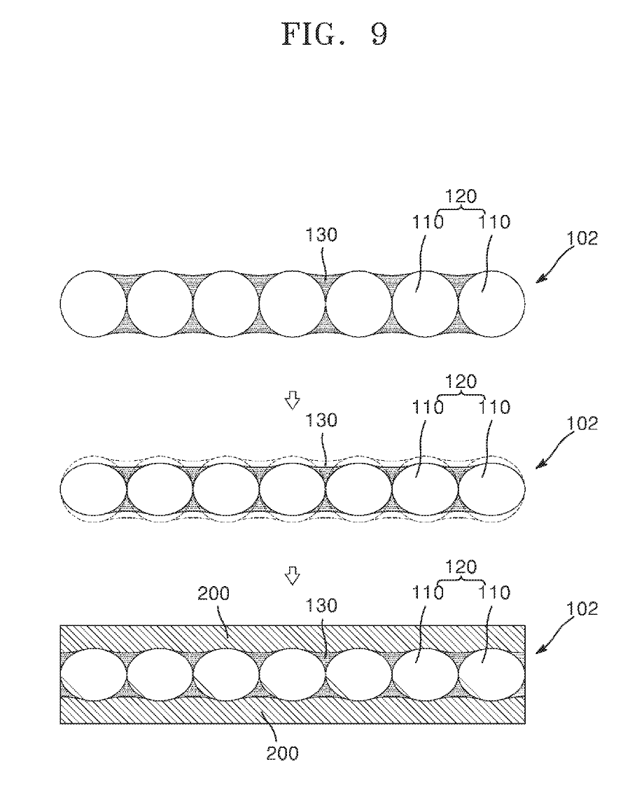

FIG. 9 is a view illustrating a process of manufacturing a carbon fiber layer to which a carbon coating is applied according to a second embodiment of the present invention;

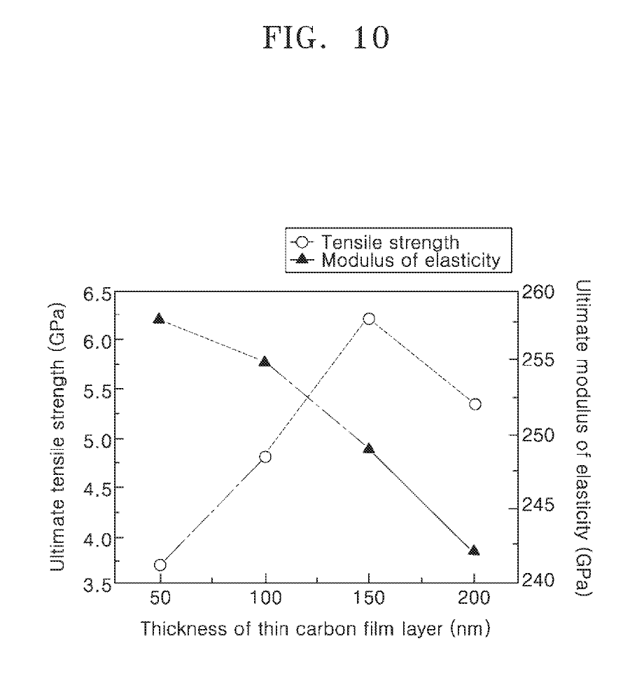

FIG. 10 illustrates ultimate tensile strength and modulus of elasticity of a carbon fiber layer to which a carbon coating is applied according to an embodiment of the present invention;

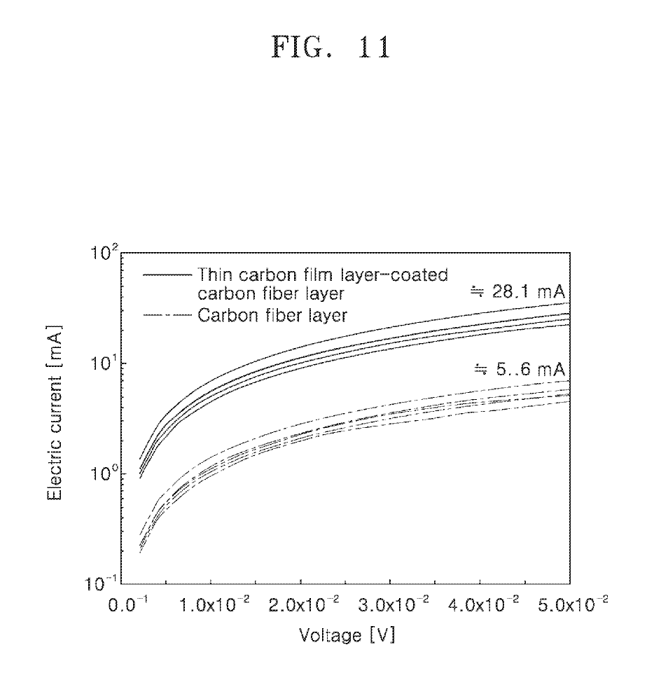

FIG. 11 illustrates electric current-voltage characteristics before and after formation of a thin carbon film layer in a carbon fiber layer to which a carbon coating is applied according to an embodiment of the present invention;

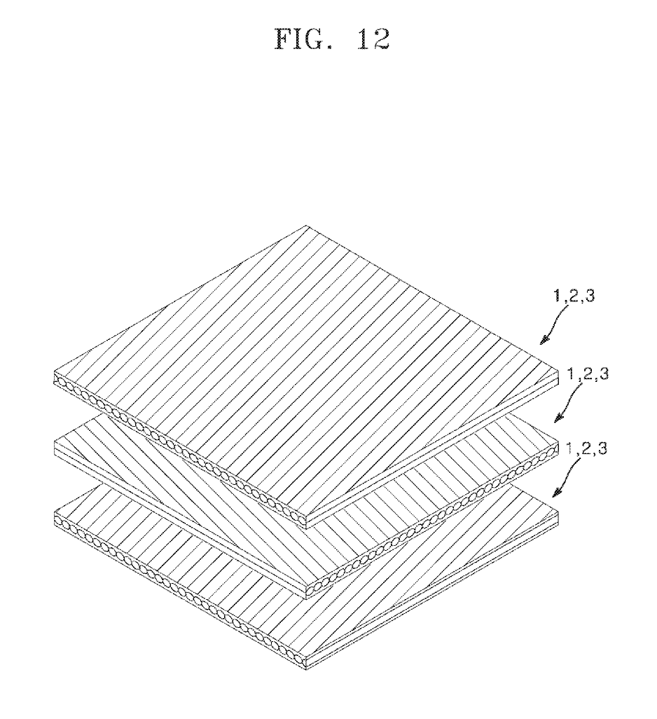

FIG. 12 is a view illustrating that a plurality of carbon fiber layers to which a carbon coating is applied according to an embodiment of the present invention are arranged; and

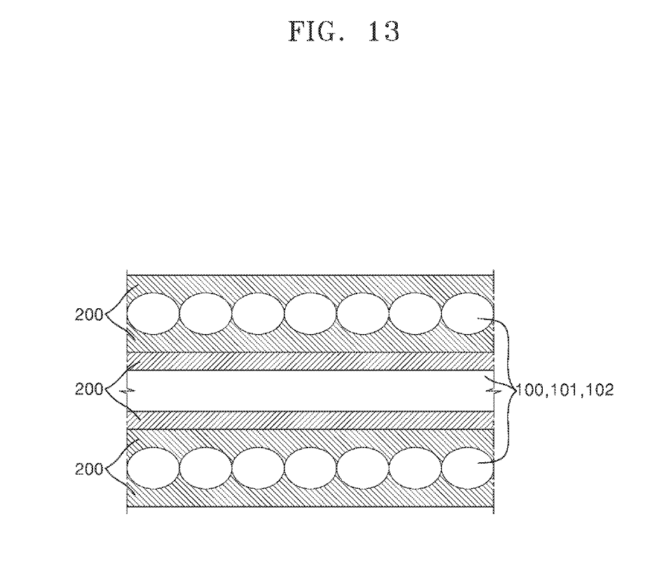

FIG. 13 is a cross-sectional view illustrating that carbon fiber layers to which a carbon coating is applied according to an embodiment of the present invention are laminated.

### DETAILED DESCRIPTION

Hereinafter, an exemplary embodiment of a carbon fiber layer to which a carbon coating is applied according to embodiments of the present invention will be described with reference to the accompanying drawings. In the process, thicknesses of lines, sizes of constituent elements and the like illustrated in the drawing may be exaggerated for clarity and convenience in explanation.

In addition, some terms described below are defined by considering functions in embodiments of the present invention and meanings may vary depending on a user or operator's intentions or customs. Therefore, the meanings of terms should be interpreted based on the content throughout this specification in which embodiments of the present invention is described.

FIG. 1 is a perspective view of a carbon fiber layer to which a carbon coating is applied according to a first embodiment of the present invention, FIG. 2 is an A-A cross-sectional view of FIG. 1, and FIG. 3 is a B-B cross-sectional view of FIG. 1.

FIG. 4 is a perspective view of a carbon fiber layer to which a carbon coating is applied according to a second embodiment of the present invention, FIG. 5 is a C-C cross-sectional view of FIG. 4, and FIG. 6 is a D-D cross-sectional view of FIG. 4.

Referring to FIGS. 1 to 6, a carbon fiber layer 1 to which a carbon coating is applied according to an embodiment of the present invention includes a carbon fiber layer 100 and a thin carbon film layer 200. The carbon fiber layer 1 to which a carbon coating is applied has, for example, a planar shape, and may also be formed in a non-planar shape such as a curved or three-dimensional shape.

The carbon fiber layer 100 includes a plurality of carbon fibers 110 alone or a carbon fiber-connecting material 130 which is a resin connecting the carbon fibers 110 to be described below.

That is, the carbon fibers 110 are woven in a carbon fiber layer 101 according to a first embodiment, and the carbon fibers 110 arranged in parallel are bound and fixed by the carbon fiber-connecting material 130 in a carbon fiber layer 102 according to a second embodiment.

Whether or not the carbon fibers 110 are woven, an arrangement form and whether or not the carbon fiber-connecting material 130 is applied may be varied depending on an environment in which carbon fiber layers 1, 2, 3 to which a carbon coating is applied are mounted, required rigidity and the like.

FIG. 7 is a view illustrating that carbon fibers are woven in a carbon fiber layer to which a carbon coating is applied according to a first embodiment of the present invention.

Referring to FIGS. 1 to 3 and 7, the carbon fiber layer 101 according to a first embodiment of the present invention is formed by weaving a plurality of carbon fibers 110. The woven carbon fiber layer 101 refers to a layer formed by weaving carbon fibers 110 crisscrossing at a predetermined angle, for example, about 90 degrees.

In the carbon fiber layer 101 according to a first embodiment of the present invention, the carbon fiber 110 is fixed through a weaving method, and thus a shape of the carbon fiber layer 101 may be maintained even when a resin such as epoxy is not applied to fix the carbon fiber 110.

Referring to FIGS. 4 to 6, the carbon fiber layer 102 according to a second embodiment of the present invention includes the carbon-arranged layer 120 and the carbon fiber-connecting material 130.

The carbon-arranged layer 120 is formed by arranging a plurality of carbon fibers 110 in parallel, and the carbon fiber-connecting material 130 fills a space between a plurality of carbon fibers 110 to bind and fix the carbon fibers 110.

When the carbon fibers 110 are arranged in parallel to form the carbon-arranged layer 120 and then fixed through the carbon fiber-connecting material 130, a process of weaving the carbon fibers 110 is unnecessary. Also, since an overlapped portion is decreased by interlaminating the carbon fibers 110 compared to when the carbon fibers 110 are woven, it is possible to reduce the cost and weight required for manufacturing the carbon-arranged layer 120 by reducing an amount of the carbon fiber 110 required per unit area.

In an embodiment of the present invention, the carbon fiber-connecting material 130 includes a thermosetting resin such as epoxy, unsaturated polyester or the like.

The thin carbon film layer 200 is deposited on surfaces of carbon fiber layers 100, 101, 102 and includes carbon. In an embodiment of the present invention, the thin carbon film layer 200 is deposited on both surfaces of carbon fiber layers 100, 101, 102 by a dry-plating method (physical vapor deposition).

In an embodiment or the present invention, the thin carbon film layer 200 is applied to the carbon fiber layers 100, 101, 102 by a sputtering method in which the thin carbon film layer 200 is formed on the carbon fiber layers 100, 101, 102 by accelerating gas such as argon ionized by generating plasma at a relatively low degree of vacuum for collisions with a target.

FIG. 8 is a view illustrating a process of manufacturing a carbon fiber layer to which a carbon coating is applied according to a first embodiment of the present invention, and FIG. 9 is a view illustrating a process of manufacturing a carbon fiber layer to which a carbon coating is applied according to a second embodiment of the present invention.

Referring to FIGS. 8 and 9, in an embodiment of the present invention, the thin carbon film layer 200 is applied to the carbon fiber layers 100, 101, 102 after surfaces of the carbon fiber layers 100, 101, 102 are etched. When the surfaces of the carbon fiber layers 100, 101, 102 are etched, the carbon fiber layers 100, 101, 102 which are curved due to the carbon fiber 110 with an approximately circular cross section are flattened, and thus a thickness deviation of the thin carbon film layer 200 applied to the surfaces of the carbon fiber layers 100, 101, 102 may be reduced.

Accordingly, embodiments of the present invention can prevent the mechanical strength, thickness and electrical properties of the carbon fiber layers 1, 2, 3 to which a carbon coating is applied from varying depending on a position by adjusting a thickness of the thin carbon film layer 200 applied to the carbon fiber layers 100, 101, 102 to be constant.

FIG. 10 illustrates ultimate tensile strength and modulus of elasticity of the carbon fiber layer to which a carbon coating is applied according to an embodiment of the present invention.

Referring to FIG. 10, in an embodiment of the present invention, the applied thin carbon film layer 200 has a thickness of 100 to 200 nm, and preferably, 145 to 155 nm. FIG. 10 illustrates a change in ultimate tensile strength and modulus of elasticity of the carbon fiber layers 1, 2, 3 to which a carbon coating is applied depending on a thickness of the thin carbon film layer 200.

Referring to FIG. 10, compared to the carbon fiber layers 100, 101, 102 to which a carbon coating is not applied having an ultimate tensile strength of 2.7 GPa, the carbon fiber layers to which the thin carbon film layer 200 is applied so as to have a thickness of 100 to 200 nm have an ultimate tensile strength of 4.7 to 6.2 GPa, which is about 1.7 to 2.3 times higher.

In particular, when the thin carbon film layer 200 has a thickness of 145 to 155 nm, the carbon fiber layers 1, 2, 3 to which a carbon coating is applied maintains an ultimate modulus of elasticity similar to that of the carbon fiber layers 100, 101, 102 to which the thin carbon film layer 200 is not applied, and has an ultimate tensile strength of about 6.2 GPa, thereby rigidity is significantly increased about 2.3 times.

Therefore, when it is necessary to reduce volume and weight while requiring mechanical strength above the set level such as in an apparatus such as a rail vehicle, an automobile, an aircraft and the like, the carbon fiber layers 1, 2, 3 to which a carbon coating is applied according to embodiments of the present invention may have significantly reduced volume and weight and simultaneously exhibit satisfactory rigidity required for the apparatus compared to the carbon fiber layers 100, 101, 102 to which a carbon coating is not applied. Therefore, when the carbon fiber layers 1, 2, 3 are applied in the above fields, the performance of the apparatus may be significantly improved.

FIG. 11 illustrates electric current-voltage characteristics before and after formation of a thin carbon film layer in a carbon fiber layer to which a carbon coating is applied according to an embodiment of the present invention.

Referring to FIG. 11, the carbon fiber layers 1, 2, 3 to which a carbon coating is applied according to an embodiment of the present invention may exhibit improved electrical performance compared to the carbon fiber layers 100, 101, 102 to which the thin carbon film layer 200 is not applied.

FIG. 11 is a graph illustrating electric current-voltage (IV) characteristics measured when samples of the carbon fiber layers 100, 101, 102 with a size of 30 mm×30 mm are coated with the thin carbon film layer 200 so that the thin carbon film layer has a thickness of 145 to 155 nm and when the samples are not subjected to a carbon coating.

The process conditions are shown in the following Table 1.

TABLE 1

| Sample Identification | Conditions |
|---|---|
| Base pressure(Torr) | 5.0 × 10⁻⁶ |
| Working pressure(Torr) | 2.0 |
| Graphite target power density (W/cm²) | 2.0 × 10⁻³ |
| DC power (A) | 50 |
| Deposition time (min) | 20 |
| Film thickness (nm) | 145 to 155 |

Referring to Table 1 and FIG. 11, when the thin carbon film layer 200 having a thickness of 145 to 155 nm is applied to the carbon fiber layers 100, 101, 102, the electric current values of the carbon fiber layers are about 6 times higher than those when the thin carbon film layer 200 is not applied to the carbon fiber layers 100, 101, 102 at the same voltage.

That is, it is interpreted that when the thin carbon film layer 200 having a thickness of 145 to 155 nm is applied to the carbon fiber layers 100, 101, 102, electrical resistivity is decreased, and thus when the thin carbon film layer 200 having a thickness within the above range is applied, mechanical strength can be increased and electrical performance can be improved as described above. Hereinafter, the operation principle and effect of the carbon fiber layers 1, 2, 3 to which a carbon coating is applied according to an embodiment of the present invention will be described as follows.

In a carbon fiber layer 2 to which a carbon coating is applied in a first embodiment of the present invention, a plurality of carbon fibers 110 are woven to manufacture a carbon fiber layer 101, and then the carbon fiber layer 101 is etched to improve flatness of a surface of the carbon fiber layer 101.

After the carbon fiber layer 101 is etched, the thin carbon film layer 200 is formed on one surface or both surfaces of the carbon fiber layer 101 by a sputtering method, thereby high elasticity of the carbon fiber layer 101 is maintained and simultaneously rigidity thereof is significantly increased.

In a carbon fiber layer 3 to which a carbon coating is applied in a second embodiment of the present invention, a plurality of carbon fibers 110 are arranged to manufacture a carbon-arranged layer 120, and then the carbon fibers 110 in the carbon-arranged layer 120 are bound and fixed through a carbon fiber-connecting material 130 such as epoxy or the like.

When the carbon fibers 110 are fixed through the carbon fiber-connecting material 130, the carbon fiber layer 102 is etched, and then the thin carbon film layer 200 is applied to one surface or both surfaces of the carbon fiber layer 102 by a sputtering method.

FIG. 12 is a view illustrating that a plurality of carbon fiber layers to which a carbon coating is applied according to an embodiment of the present invention are arranged, and FIG. 13 is a cross-sectional view illustrating that carbon fiber layers to which carbon coating is applied according to an embodiment of the present invention are laminated.

Referring to FIGS. 12 and 13, in order to reinforce the rigidity of the carbon fiber layers 1, 2, 3 to which a carbon coating is applied according to an embodiment of the present invention and to prevent the layers from being torn in a specific direction, a plurality of carbon fiber layers 100, 101, 102 may be laminated. In an embodiment of the present invention, in order to laminate the plurality of carbon fiber layers 100, 101, 102, an adhesive material including epoxy or the like may be additionally used between the carbon fiber layers 100, 101, 102 or the thin carbon film layers 200 to increase interlayer adhesive strength.

In particular, the carbon fiber layer 102 according to a second embodiment may have low resistance in a specific direction because the carbon fibers 110 are arranged in one direction. Therefore, rigidity may be prevented from being degraded according to a direction by laminating the carbon fiber layer 102 while varying a direction of the carbon fiber 110.

Therefore, the carbon fiber layers 1, 2, 3 to which a carbon coating is applied according to an embodiment of the present invention can maintain high elasticity of the carbon fiber layers 100, 101, 102, have reinforced rigidity, and simultaneously have increased adhesive strength between the carbon fiber layers 100, 101, 102 and the thin carbon film layer 200 by sputtering a material including carbon on the surfaces of the carbon fiber layers 100, 101, 102 such as CFRP to form the thin carbon film layer 200.

In addition, in the carbon fiber layers 1, 2, 3 to which a carbon coating is applied according to an embodiment of the present invention, the thin carbon film layer 200 may be uniformly applied due to a decrease in bending of the carbon fiber layers 100, 101, 102 by applying the thin carbon film layer 200 to one surface or both surfaces of the carbon fiber layers 100, 101, 102 after the carbon fiber layers 100, 101, 102 are etched.

Additionally, the carbon fiber layers 1, 2, 3 to which a carbon coating is applied according to an embodiment of the present invention exhibit significantly increased rigidity compared to carbon fiber layers 100, 101, 102 such as CFRP to which the thin carbon film layer 200 is not applied and the like, and thus the number, weight and cost of the carbon fiber layers 100, 101, 102 for realizing the same strength may be reduced.

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1. A carbon fiber layer to which a carbon coating is applied, comprising:
a carbon fiber layer formed by arranging a plurality of carbon fibers; and
a thin carbon film layer applied to a surface of the carbon fiber layer and including carbon.

2. The carbon fiber layer according to claim 1, wherein the carbon fiber layer is formed by weaving the plurality of carbon fibers.

3. The carbon fiber layer according to claim 1, wherein the carbon fiber layer comprises:
a carbon-arranged layer including the plurality of carbon fibers arranged in parallel; and
a carbon fiber-connecting material filling a space between the plurality of carbon fibers to bind the carbon fibers.

4. The carbon fiber layer according to claim 3, wherein the carbon fiber-connecting material comprises a thermosetting resin.

5. The carbon fiber layer according to claim 4, wherein the carbon fiber-connecting material comprises epoxy or unsaturated polyester.

6. The carbon fiber layer according to claim 1, wherein the thin carbon film layer is deposited on both surfaces of the carbon fiber layer.

7. The carbon fiber layer according to claim 6, wherein the thin carbon film layer is applied to the carbon fiber layer by a dry-plating method.

8. The carbon fiber layer according to claim 7, wherein the thin carbon film layer is applied to the carbon fiber layer by a sputtering method.

9. The carbon fiber layer according to claim 8, wherein the thin carbon film layer is applied to the carbon fiber layer after a surface of the carbon fiber layer is etched.

10. The carbon fiber layer according to claim 9, wherein the thin carbon film layer is applied to a surface of the carbon fiber layer after a surface of the carbon fiber layer is flattened through etching.

11. The carbon fiber layer according to claim 9, wherein the thin carbon film layer applied to the carbon fiber layer has a thickness of 100 to 200 nm.

12. The carbon fiber layer according to claim 11, wherein the thin carbon film layer applied to the carbon fiber layer has a thickness of 145 to 155 nm.
